(19) United States
(12) Patent Application Publication
(10) Pub. No.: US 2008/0228519 A1
(43) Pub. Date: Sep. 18, 2008

(54) System and Method for Optimizing Prescription Delivery Related Applications

(76) Inventor: Mauricio A. Leon, San Diego, CA (US)

Correspondence Address: Mauricio A. Leon, 9658 Deer Trail Way, San Diego, CA, 92127, US

(21) Appl. No.: 11/619,017

(22) Filed: Jan. 2, 2007

Related U.S. Application Data
(60) Provisional application No. 60/756,044, filed on Jan. 4, 2006.

(51) Int. Cl. G06Q 50/00

(52) U.S. Cl. 705/2

(57) ABSTRACT

The present invention concerns a health service system that is configured to enable a patient to obtain prescriptions in a secure, accurate, automated, convenient, manner that is optimized for the particular patient. The health service system includes an IT (information technology) system that is coupled to a network that is in communication with a patient system, a healthcare provider system, and a number of pharmacies. When a healthcare provider generates a prescription for a patient, the prescription is transferred to the health service system. The health service system processes the prescription and thereby defines offer information for each of a plurality of pharmacies. The offer information is then delivered and/or presented to enable the patient to select an offer. Upon selecting an offer, order information is then transferred to one of the plurality of pharmacies.

### RELATED APPLICATIONS

This non-provisional application claims priority to U.S. Provisional Application Ser. No. 60/756,044, Entitled “System and Method for Optimizing Prescription Delivery” by Mauricio Arturo Leon, filed on Jan. 4, 2006, incorporated herein by reference under the benefit of U.S.C. 119(e).

### FIELD OF INVENTION

The present invention relates to systems for delivering medications to patients and more particularly for a system that enables a patient to obtain a prescription in the most convenient and optimized manner possible.

### BACKGROUND OF THE INVENTION

Generally speaking, dispensing prescriptions today is a varied process having shortcomings that are exacerbated by the use of handwritten prescriptions, traveling and commuting, and lack of effective communication. Handwritten prescriptions, of course, are prone to error. They also require a patient to inconveniently hand carry a prescription to a pharmacy and then wait for an order to be processed.

Traveling and/or commuting add their own issues. Often a patient is “set up” in the system of one pharmacy but due to travel or commuting requirements would prefer to pick up an order at another pharmacy. The other pharmacy may not be set up for the patient or the patient may not be aware of the best pharmacy locations at a new locale.

Finally, certain pharmacies would like to offer incentives to draw in new patients. But because getting prescriptions from different pharmacies or pharmacy locations is often inconvenient, patients tend to keep going to one pharmacy that they have dealt with in the past.

What is needed is a system that can reduce these and other shortcomings.

### BRIEF DESCRIPTION OF THE DRAWINGS

FIG. 1 is a block diagram representation of an exemplary “network ecosystem” incorporating the present invention.

FIG. 2 is a flow chart representation of a process incorporating a method the present invention.

FIG. 3A is a block diagram representation of a first exemplary embodiment of a health service system of the present invention.

FIG. 3B is a block diagram representation of a second exemplary embodiment of the health service system of the present invention that differs from FIG. 3A in that a portion of the health service system resides with and/or is associated with hardware owned, operated, and/or residing with a pharmacy.

FIG. 4 is a block diagram representation of an embodiment of the health service system with emphasis on details of a pharmacy subsystem 54 or 54′.

FIG. 5 is a flow chart representation of an exemplary embodiment of a method by which a pharmacy system interacts with the health service system.

FIG. 6 is a process flow diagram representation of an exemplary embodiment of elements 200 and 202 discussed with respect to FIG. 5.

FIG. 7 is a process flow diagram representation of an exemplary embodiment of element 204 discussed with respect to FIG. 5.

FIG. 8 is a flow chart representation of an exemplary embodiment of the operation of prescription response (or quotation) server 110.

FIG. 8A is an exemplary embodiment of a response to a request for quote.

FIG. 9 is a process flow diagram representation of an exemplary embodiment of element 236 or rule management discussed with respect to FIG. 7.

FIGS. 9A, 9B, and 9C are exemplary embodiments of elements 272, 274, and 276, respectively, discussed with respect to FIG. 9.

FIG. 10 is a block diagram representation of patient subsystem 52 discussed with respect to FIGS. 3A and 3B.

FIG. 11 is a flow chart representation of an interaction between patient subsystem 52 and patient system 6.

FIG. 12 is a flow chart representation of a process of opening an account—element 350 discussed with respect to FIG. 11.

FIG. 13 is an exemplary embodiment of element 352 of FIG. 1, wherein a patient completes an initial account set-up, depicted in process flow diagram form.

FIG. 14 is an exemplary embodiment of element 354 of FIG. 1, wherein a patient uses health service system 4, depicted in process flow diagram form.

FIG. 15 is an exemplary embodiment of element 392 of FIG. 14, wherein a patient manages an account with health service system 4, in process flow diagram form.

FIG. 16 is an exemplary embodiment of element 374 of FIG. 13, wherein a patient enters pharmacy preference information, in process flow diagram form.

FIG. 17 is an exemplary embodiment of element 376 of FIG. 13 or of element 406 of FIG. 15, wherein a patent enters notification/response preference information, in process diagram form.

FIG. 18 is an exemplary embodiment of element 378 of FIG. 13 or element 404 of FIG. 15, wherein a patient enters offer type preference information, in flow chart form.

FIG. 19 is an exemplary embodiment of element 394 of FIG. 14, wherein a patient manages prescriptions, in process flow diagram form.

FIG. 19A is an exemplary embodiment of RFQ information discussed with respect to FIG. 19.

FIG. 20 is an exemplary embodiment of element 446 in FIG. 19, wherein a patient receives real time offers from health service system 4, in process flow diagram form.

FIG. 21 is an exemplary embodiment of the operation of quotation subsystem 56 of FIG. 253A or 3B, depicted in flow chart form.

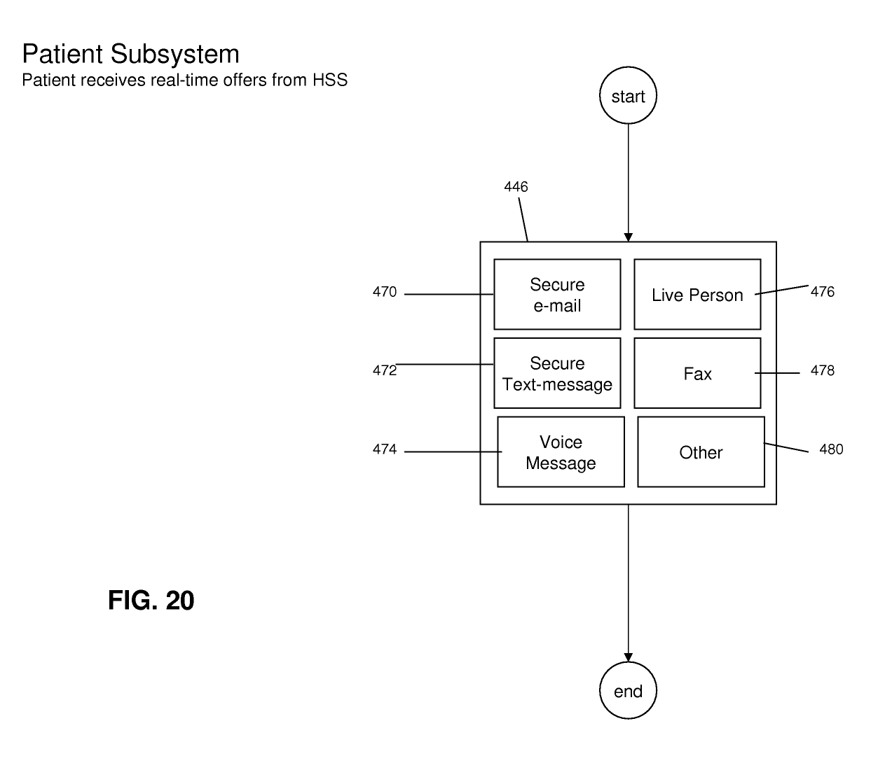

Note: Some depictions of processes are described as being depicted in “process flow diagram” form. Process flow diagrams are similar to flow charts. A larger block may contain two or more smaller blocks each of which may occur in parallel or in serial or in alternative for example. As an example, FIG. 20 has larger block 446 that includes smaller blocks 470, 472, 474, 476, 478, and 480, each of which may occur in parallel, in series (one after the other), a combination of series and parallel, in random order, in alternative (some but not all may occur), and/or any combination of the above.

### DETAILED DESCRIPTION OF THE PREFERRED EMBODIMENTS

The present invention concerns a health service system that is configured to enable a patient to obtain prescriptions in a secure, accurate, automated, and convenient manner that is optimized for the particular patient. The health service system includes an IT (information technology) system that is coupled to a network that is in communication with a patient system, a healthcare provider system, and a number of pharmacies.

When a healthcare provider generates a prescription for a patient, the prescription is transferred to the health service system. The health service system processes the prescription and thereby obtains offer information for each of a plurality of pharmacies.

The offer information is then transferred to a patient system to enable the patient to select an offer. When a patient selects an offer, this generates selection information that is then transferred to the pharmacy corresponding to the offer. The patient will then obtain the prescription in any number of selectable ways.

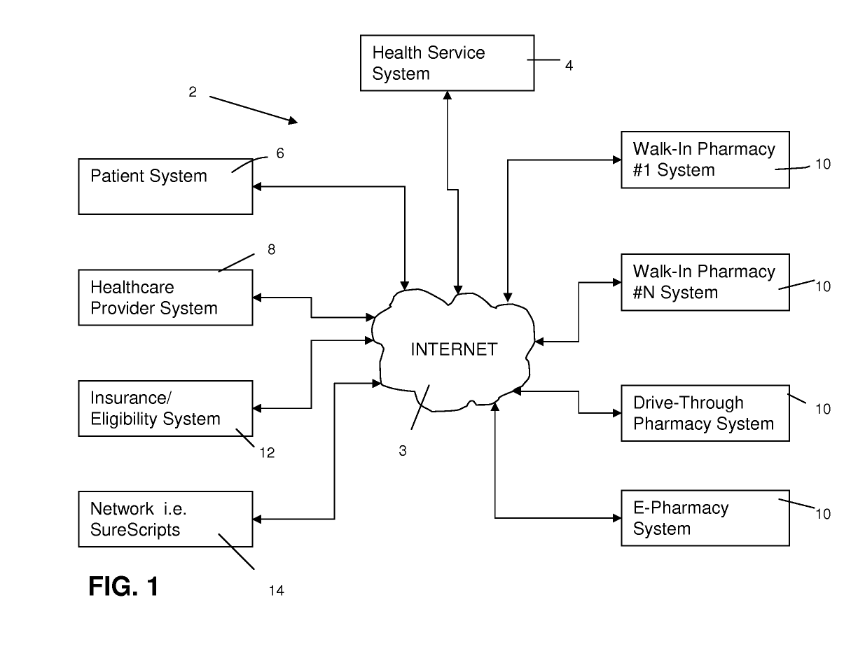

An exemplary “network ecosystem” 2 of the present invention is depicted in block diagram form in FIG. 1. A health service system 4 is coupled via a network 3 such as the Internet to a patient system 6, a healthcare provider system 8, a plurality of pharmacies or pharmacy systems 10, insurance or eligibility system 12, and an additional network intermediary system 14.

Health Service System 4: the health service system 4 is configured to enable a patient to optimally manage the process from receiving a prescription from a healthcare provider to filling the prescription. In one embodiment, the health service system 4 includes an IT (information technology) system that is configured to communicate with the patient system 6, the healthcare provider system 8, each of the pharmacy systems 10, the insurance system 12, and the network intermediary system 14.

Patient System 6: The patient system 6 is any device utilized by the patient to communicate with the health service system 4. It can include a personal computer, a phone, a PDA, or other devices. In one embodiment, the patient system 6 would include a web browser that enables a web interface to be utilized in controlling prescription procurement operations of the patient system 6.

Healthcare Provider System 8: In a preferred embodiment, each healthcare provider system 8 has an IT (information technology) system that provides prescriptions in electronic form to the health service system 4.

Pharmacy Systems 10: The pharmacies that can provide prescriptions can include walk-in pharmacies, drive-through pharmacies, e-pharmacies, or other types of pharmacies such as those that operate in a hybrid mode. An e-pharmacy would be a pharmacy that receives an order only by telephone and/or the Internet and then delivers the order to the customer. A hybrid pharmacy may be a combination of a walk-in pharmacy, a drive-through pharmacy, or an e-pharmacy. Element 10 refers either to a pharmacy, pharmacies, a pharmacy IT (information technology) system, or a plurality of pharmacy IT systems.

Rx: A prescription for a therapeutically beneficial product or procedure or a medication. Note—although the discussion that follows typically refers to human patients, the present invention is also applicable to veterinarian (animals and/or pets) applications. Thus, the term “patient” may refer to a pet and/or animal, the term Rx also encompasses therapeutically beneficial products or procedures or a medications for pets and/or animals. A “pharmacy” may refer to a dispenser of medications for animals and/or pets. A “healthcare provider” may refer to a veterinarian.

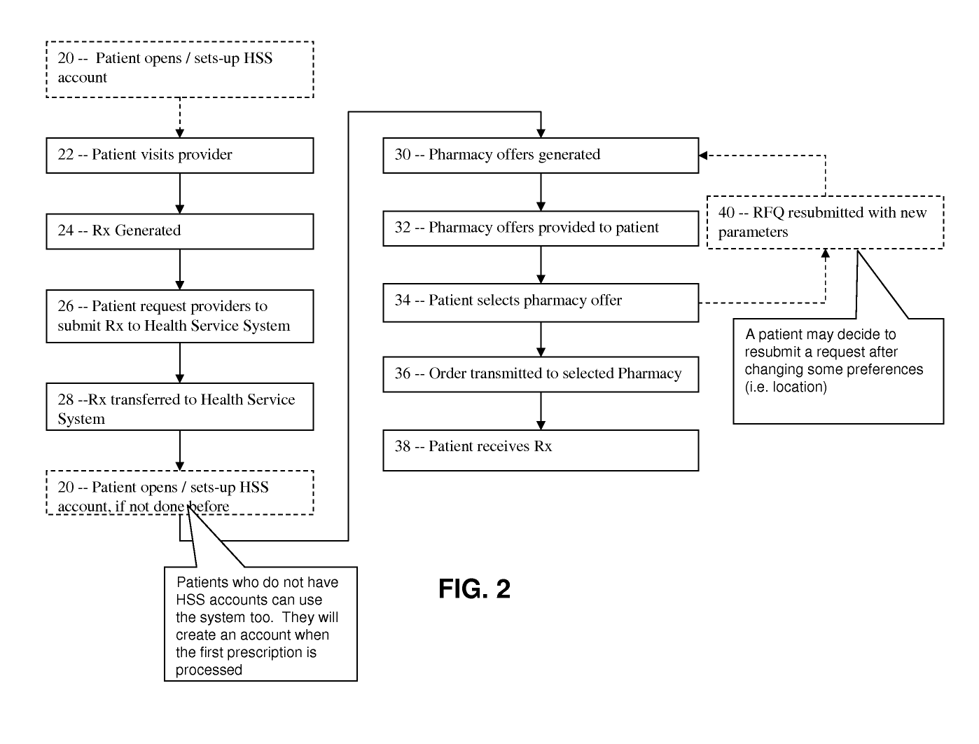

FIG. 2 is a flow chart representation of an exemplary embodiment of an optimized prescription procurement process of the present invention. According to 20, a patient opens and sets up an account with health service system 4. This step may occur initially or it can occur at other times such as during a visit to a healthcare provider.

According to 20, the patient provides pharmacy preference information to the health service system 4 that defines a plurality of pharmacy systems 10 from which to generate offers according to 30 (to be discussed later). In one embodiment health service system 4 receives setup information from the patient system 6 that includes the pharmacy preference information. Element 20 is not necessary if the patient already has an account with the health service system 4.

According to 22 a patient visits a healthcare provider such as a healthcare practitioner and according to 24 an Rx (a prescription for a therapeutically beneficial product or procedure or a medication) is generated for the patient.

According to 26, the patient requests that the provider submit the Rx to health service system 4. Then according to 28, the Rx is transferred to health service system 4. The health service system 4 receives prescription information from healthcare provider system 8 according to 28.

In an alternative embodiment 26 is not required in the event that the healthcare provider always transfers the Rx to health service system 4. In this alternative embodiment, the healthcare provider system 8 generates prescription information according to 24 and then transfers the prescription information to the health service system 4 according to 28.

As stated before, the patient may set up an account according to 20 before, after, or during a visit to the health care provider. In one embodiment, the health care provider would provide information to the patient during an office visit about the opportunity to have an optimized method for dispensing prescriptions according to this invention.

After receiving prescription information, the health service system 4 generates offer information according to 30. There are various ways this can take place to be discussed below.

According to 32, the health service system 4 transfers the offer information to the patient system 6 according to 32. The offer information defines a plurality of offers, each corresponding to a particular pharmacy. The patient system 6 has a user interface that displays the offers to the patient.

According to 34, the patient then makes a selection or selects an offer with the user interface of the patient system 6. When the patient makes a selection, the patient system 6 transfers offer selection information to the health service system 4 also according to 34. The selection information defines a selected offer and a selected pharmacy that is providing the selected offer.

According to 36, an order is transmitted to the selected pharmacy pursuant to the offer selection information. According to 36 the health service system 4 transfers the order information to a pharmacy system 10 either directly or indirectly via a network intermediary 14.

Finally according to 38 the patient receives the Rx in any number of ways such as driving to the pharmacy to pick up the Rx, driving to a location to receive a procedure, receiving an Rx by mail to name a few.

Referring back to element 30 of FIG. 2, the health service system gathers and/or generates offers for the patient. This can take place in a number of ways. In a first embodiment, the health service system 4 generates offers by submitting an RFQ (request for quote) to each pharmacy and then receiving offer information responses in the form of quotes that can be provided to the patient system 6. In a second embodiment, the health service system 4 holds information from each pharmacy 10 in the form of rules that define pricing and other incentives. These rules allow the health service system 4 to generate offer information responses automatically when an Rx is received at health service system 4. A third embodiment is a hybrid of the first and second embodiments for element 30 in which some offers are generated based on rules generated at health service system 4 and some are generated based on quotations from pharmacy systems 10.

Referring now to element 40 of FIG. 2, the patient may, within the process depicted in FIG. 2, revise the pharmacy preference information defining the plurality of pharmacies 10 for which to receive Rx offer information. Thus according to 40, the health service system receives pharmacy preference information from the patient system 6 that redefines the pharmacies 10 for which the health service system will provide Rx offer information to the patient system 6 according to 30. The patient may elect to perform process 40 when optimizing the pharmacy selection for travel or commuting circumstances or for other reasons.

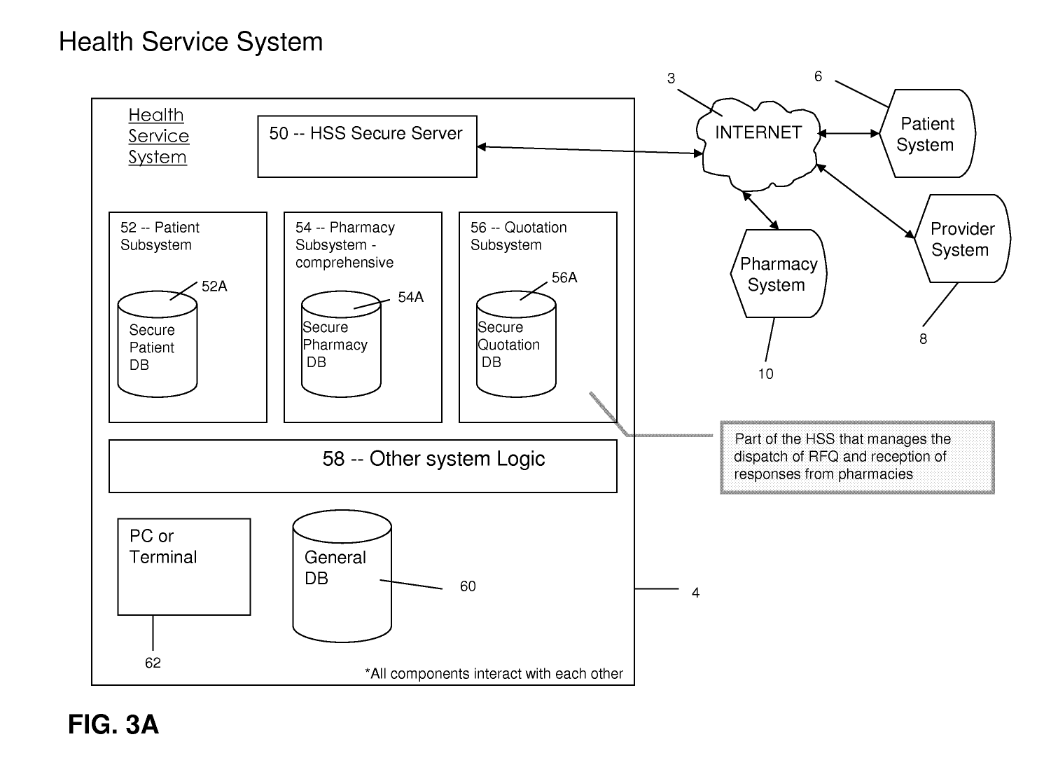

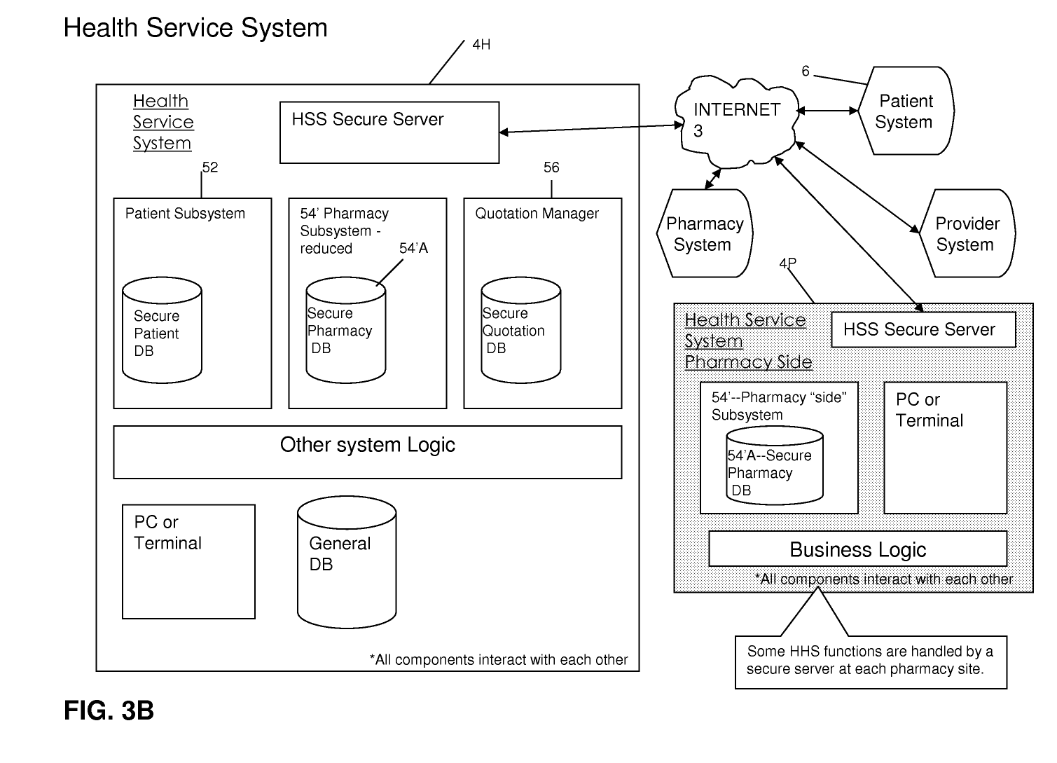

An exemplary embodiment of the health service system 4 of the present invention is depicted in block diagram form in FIG. 3A. The health service system is coupled to the Internet via secure server 50. Secure server 50 bridges communication between the Internet and internal subsystems 52-56 including a patient subsystem 52, a pharmacy subsystem 54, and a quotation subsystem 56.

Patient subsystem 52 is directly controlled by the patient and stores patient data in secure patient database 52A. Patient subsystem 52 is linked to the Internet 3 via the secure server 50. Patient subsystem 52 is configured to receive Rx information from healthcare provider system 8 and setup information (including pharmacy network selection information) from patient system 6. Patient subsystem 52 is configured to provide offer information to patient system 6. Patient subsystem 52 is configured to receive offer selection information from patient system 6 and to provide order information to pharmacy system 10.

Secure patient database 52A stores information for each of a plurality of patients who may each access patient-controlled information utilizing modules and tools provided within patient subsystem 52. The patient controlled information includes information provided by patients as well as other information received by patient subsystem 52. Although it will be described that a patient controls patient subsystem 52 it is to be understood that a multitude of patients may individually control patient subsystem 52 insofar as their own individual data in database 52A is concerned.

Pharmacy subsystem 54 is directly controlled by pharmacy system 10 and includes secure pharmacy database 54A. Pharmacy subsystem 54 is configured to receive rule information from pharmacy system 10 that may define pricing, other incentives, and offer information related to prescriptions received by a patient.

Secure pharmacy database 54A stores information for each of a plurality of pharmacies that may each access pharmacy-controlled information utilizing modules and tools provided within pharmacy subsystem 54. The pharmacy controlled information includes information provided by pharmacy systems as well as other information received by pharmacy subsystem 54. Although it will be described that a pharmacy controls pharmacy subsystem 54 it is to be understood that a plurality of pharmacies may individually control pharmacy subsystem 54 insofar as their own individual data in database 54A is concerned.

Quotation subsystem 56 manages dispatch of RFQ information to pharmacy systems 10 and receives responses from pharmacies 10.

Other components of health service system 4 include system logic 58, general database 60, and PC or terminal 62.

FIG. 3B depicts an alternative embodiment of health service system 4 that is similar to the embodiment depicted in FIG. 3A except that the functions of health service system 4 reside in two portions—4H and 4P. Portion 4H is the primary portion of health service system 4. Portion 4P is an ancillary portion of health service system 4 that is located within, associated with, and/or operated by a pharmacy.

Portions 4H and 4P together contain pharmacy subsystem 54′ that is functionally similar to pharmacy subsystem 54 of FIG. 3A. Other than the differences in the pharmacy subsystem 54′ over pharmacy subsystem 54, the remaining modules and portions (52, 56, etc.) of portion 4H are similar to those depicted for health service system 4 in FIG. 3A. In the discussions that follow it is to be understood that embodiment 54′ can be substituted for embodiment 54.

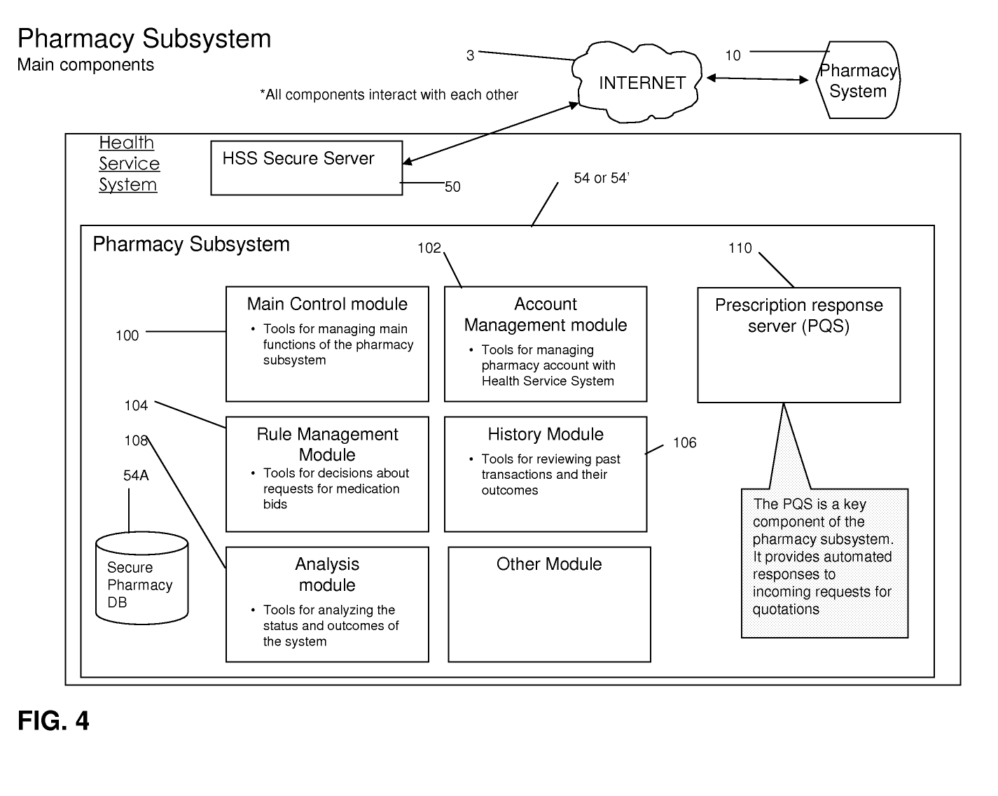

An exemplary embodiment of pharmacy subsystem 54 or 54′ but hereafter referred by numeral 54 is depicted in block diagram form in FIG. 4. Pharmacy subsystem 54 is directly controlled by pharmacies 10. In the discussion that follows we will refer to the control by one pharmacy 10 but it will be understood that provision is made for numerous pharmacies to access this function independently in health service system 4.

Pharmacy subsystem 54 includes a main control module 100, an account management module 102, a rule management module 104, a history module 106, an analysis module 108, and a prescription response server 110. The main control module 100 provides tools for managing the main or primary functions of the pharmacy subsystem 54. The main control module 100 is the command console for the pharmacy subsystem. Authorized pharmacy personnel use the main control module 100 to access all the other functions and to receive brief information about the status of the system.

Account management module 102 includes tools for to enable each pharmacy 10 to manage an account with health service system 4. These functions include, but are not limited to the definition of billing information preferences, payment methods, billing and payment history, and other functions.

Rule management module 104 includes tools for defining decisions about requests for medication bids. Thus, module 104 is utilized by the pharmacy 10 to define rules for processing Rx information. Thus, based on a particular Rx request, these rules define what incentives and/or prices are to be presented to the customer.

History module 106 provides tools for reviewing past transactions and their outcomes. This history module 106 would provide a user interface that generates charts, graphs, and figures illustrating such information as how many Rx requests have been processed, how many offers were accepted, percentage of offers accepted, etc. The history module 106 is particularly useful to the pharmacy 10 to determine how well marketing campaigns are progressing.

Analysis module 108 includes tools that allow each pharmacy 10 to analyze the status and outcomes for the system. The analysis module provides tools to find associations between RFQ information, offer responses, and filling orders, so that pharmacies could anticipate the effect of incentives or marketing programs on patient decisions.

Prescription response server 110 provides automated responses to incoming requests for quotations. When RFQ (request for quote) information is transferred to the pharmacy subsystem 54, server 110 takes the RFQ information and delivers offer information or some other response back to the patient subsystem 52 and/or the patient system 6.

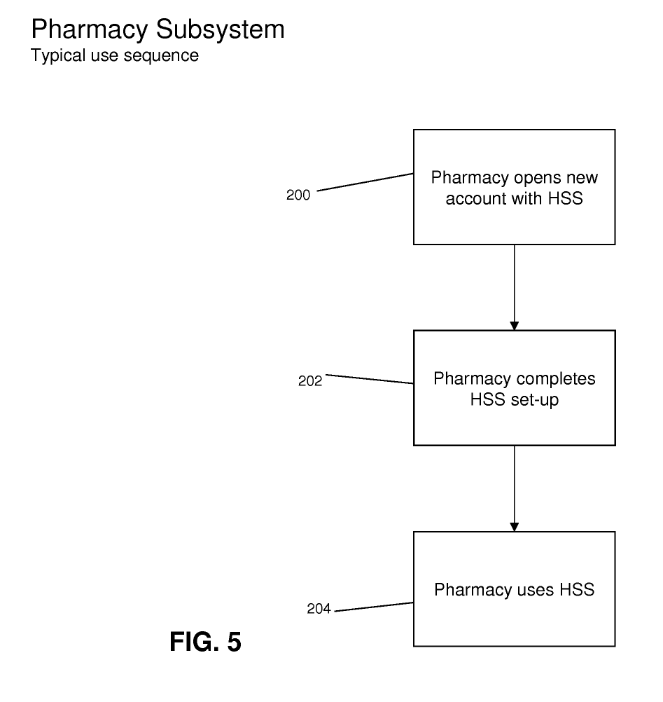

FIG. 5 depicts the interaction between the pharmacy system 10 and the health service system 4 in flow chart form. According to 200, the pharmacy 10 opens a new account with the health service system 4. In a preferred embodiment, pharmacy 10 accesses and utilizes tools from account management module 102 to transfer new pharmacy account information to pharmacy subsystem 54.

According to 202, health service system 4 (and preferably pharmacy subsystem 54) receives additional instructions defining the “set up” or further definition of the new account. In a preferred embodiment, pharmacy 10 accesses and utilizes tools from account management module 102 and/or rule management module 104 to transfer additional pharmacy information such as pharmacy account information or pharmacy set up information to pharmacy subsystem 54. Pharmacy set up information may include, for example, rule defining information that define the rules by which pharmacy subsystem 54 processes prescription RFQ information (prescription requests for quote information).

According to 204, the pharmacy system 10 can then use the health service system. This includes providing offer information and processing RFQ information.

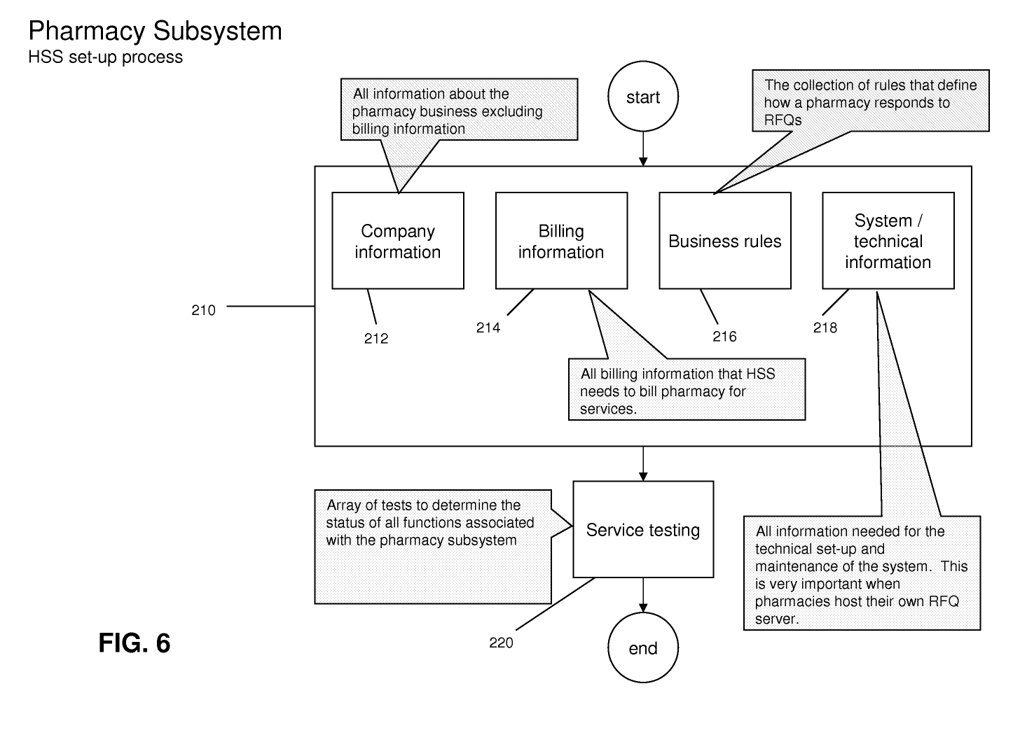

FIG. 6 is a flow chart depiction of an exemplary embodiment of elements 200 and 202 discussed with respect to FIG. 5. According to 210, the pharmacy subsystem 54 is set up or configured pursuant to the needs of a particular pharmacy 10. During process 210 pharmacy subsystem 54 receives information defining the set up of pharmacy subsystem 54 for a particular pharmacy 10. Within 210 are sub-processes 212, 214, 216, and 218.

According to 212 pharmacy 10 accesses and utilizes tools within account management module 102 to transfer company information pertaining to the particular pharmacy (excluding billing information) to the pharmacy subsystem 54. According to 214 pharmacy 10 accesses and utilizes tools within account management module 102 to transfer billing information to pharmacy subsystem 54.

According to 216 pharmacy 10 accesses and utilizes tools within rule management module 104 to transfer rule information to pharmacy subsystem 54. Rule information defines how the pharmacy subsystem 54 will respond to incoming RFQ information.

According to 218, pharmacy 10 accesses and utilizes tools in the main control module 100 to transfer technical information to pharmacy subsystem 54. Technical information in this context defines requirements for technical set-up and maintenance of the system.

According to 220, health service system 4 performs an array of tests to determine the status of all functions within the pharmacy subsystem 54.

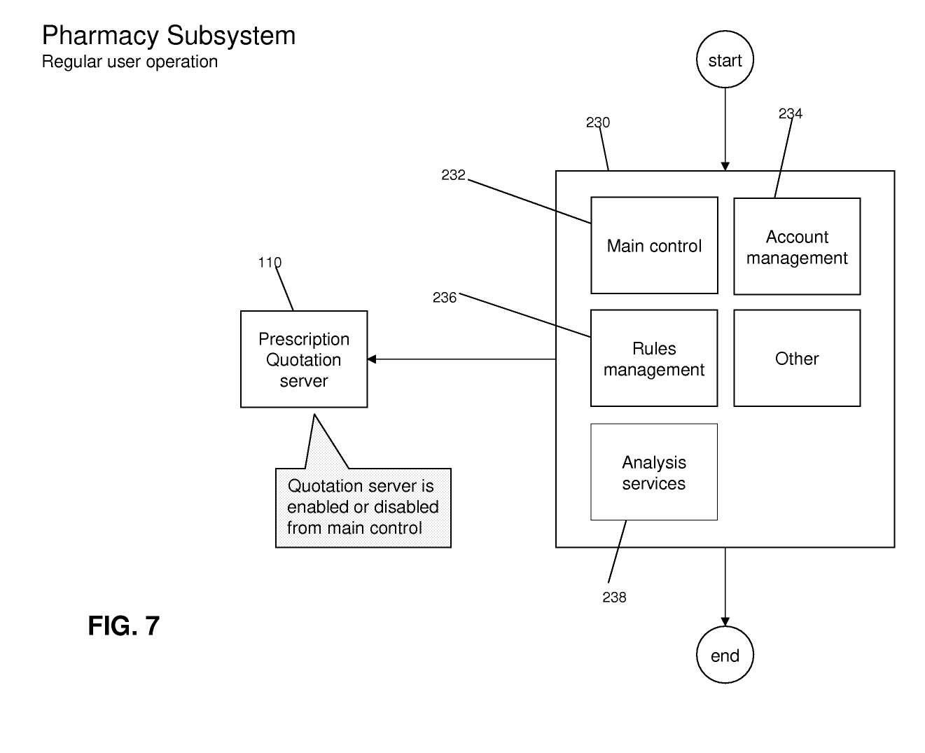

FIG. 7 is a process flow diagram depiction of an exemplary embodiment of element 204 discussed with respect to FIG. 5. FIG. 7 depicts, in process flow form, a process of ongoing usage or updating of pharmacy subsystem 54 by a pharmacy 10.

According to 230, tools from any or all of the function modules 100-108 (see FIG. 4) are accessed and utilized by a pharmacy system 10. According to 230, pharmacy subsystem 54 receives pharmacy usage information or pharmacy update information to affect or modify operation of pharmacy subsystem 54.

According to 232, the main control module 100 is accessed and utilized to send pharmacy main control information from pharmacy system 10 to pharmacy subsystem 54. This pharmacy main control information may include information that enables or disables quotation server 110.

According to 234, account management module 102 is accessed and utilized to send pharmacy account management information from pharmacy system 10 to pharmacy subsystem 54. This information may be used to update aspects of the account that pharmacy 10 has with health service system 4.

According to 236, rules management module 104 is accessed and utilized to transfer rule information from pharmacy system 10 to pharmacy subsystem 54.

According to 238, analysis module 108 is accessed and utilized to send analysis process information from pharmacy system 10 to pharmacy subsystem 54.

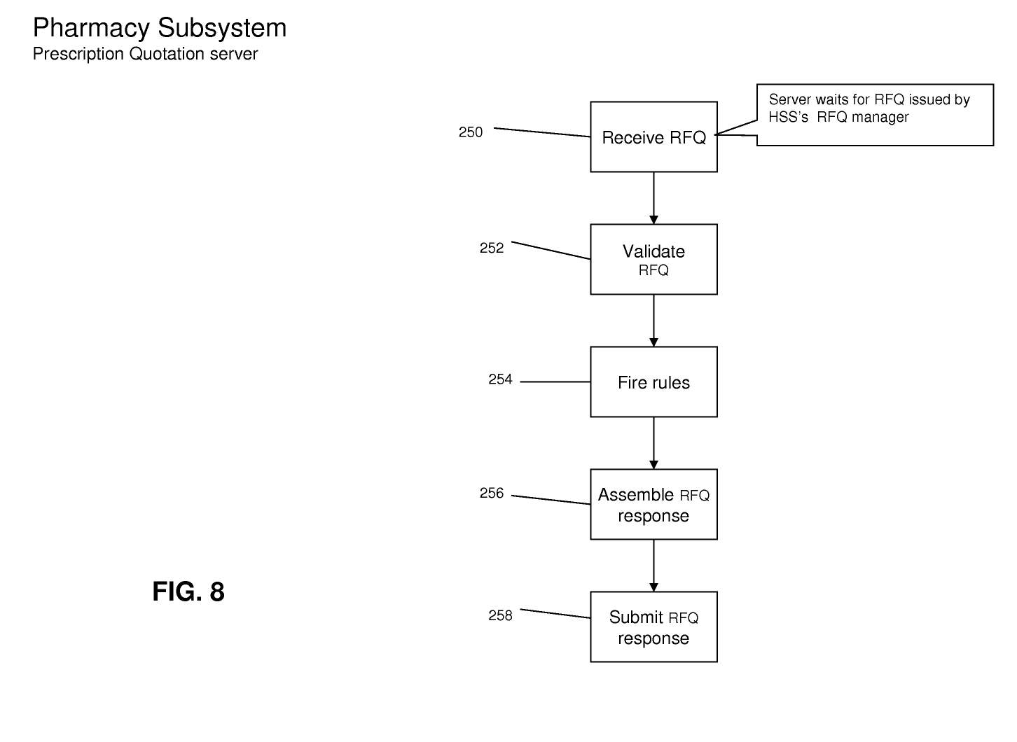

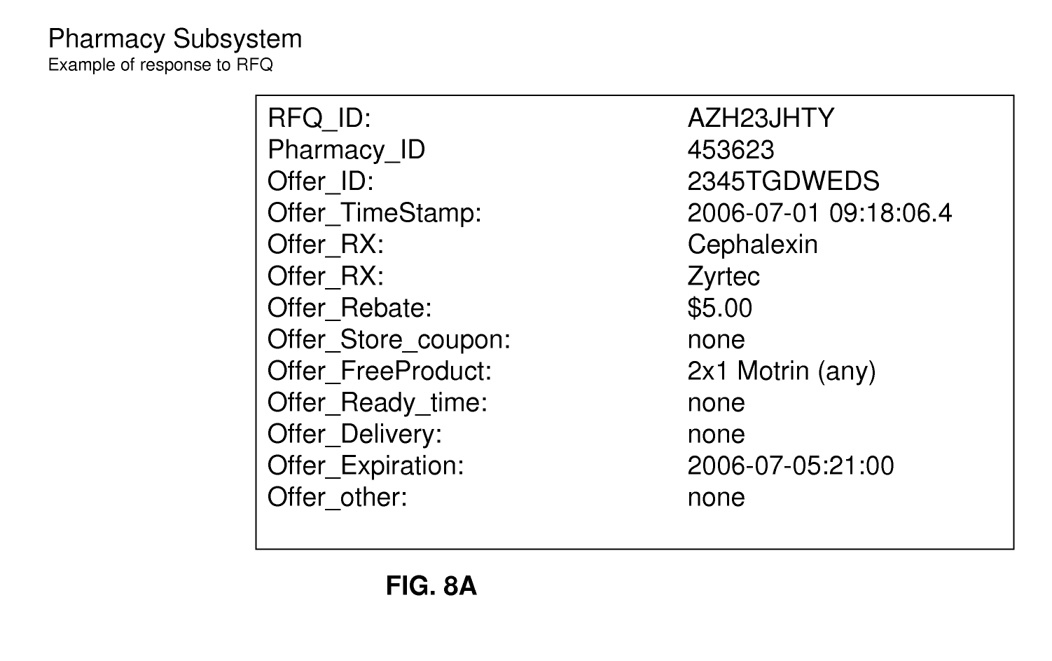

FIG. 8 is a flow chart representation of an exemplary operation of prescription response server 110. According to 250, server 110 receives an RFQ from patient subsystem 52. In one embodiment, the RFQ is a modified version of the original Rx information having patient identity information removed.

According to 252, server 110 validates the RFQ. According to 254, server 110 applies rules to the RFQ that enable the generation of a response. According to 256 server 110 assembles the response. Finally according to 258, server 110 transfers the RFQ response to patient subsystem 52. The prescription response server can maintain and execute any amount of rules. There could be multiple rule-sets that apply to a single medication, and these rule sets may be selected because of other information in the RFQ for example, the location of the prescriber, the time or date, the availability or not of patient identifiable information, etc. FIG. 8A depicts an RFQ response according to 258.

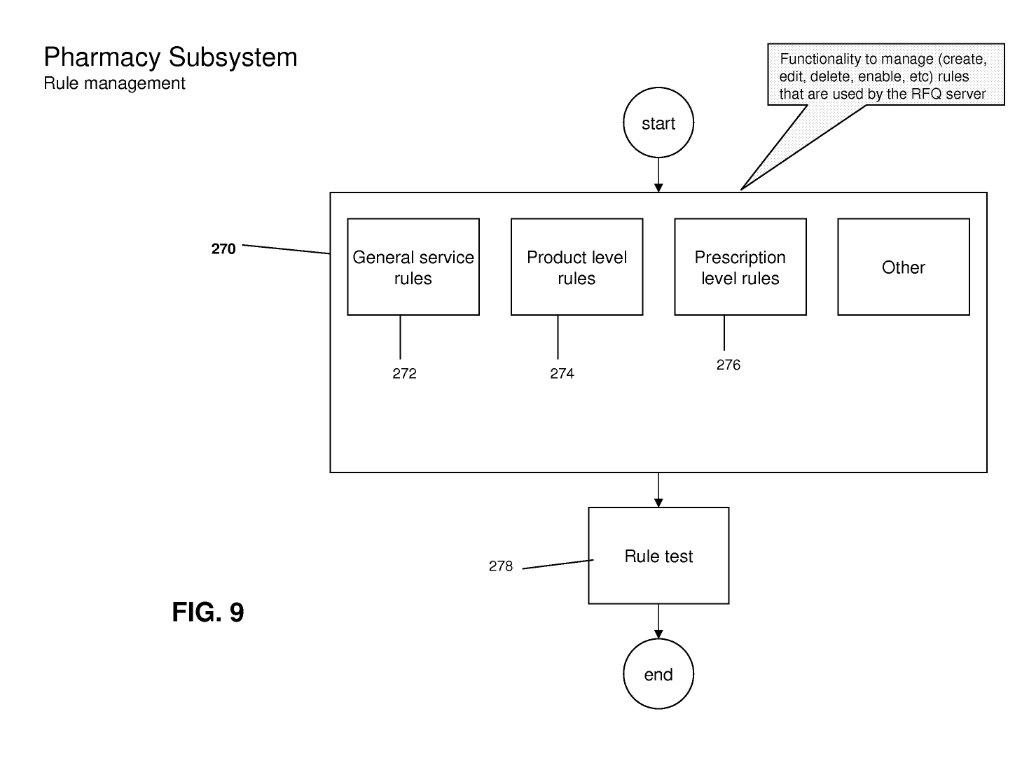

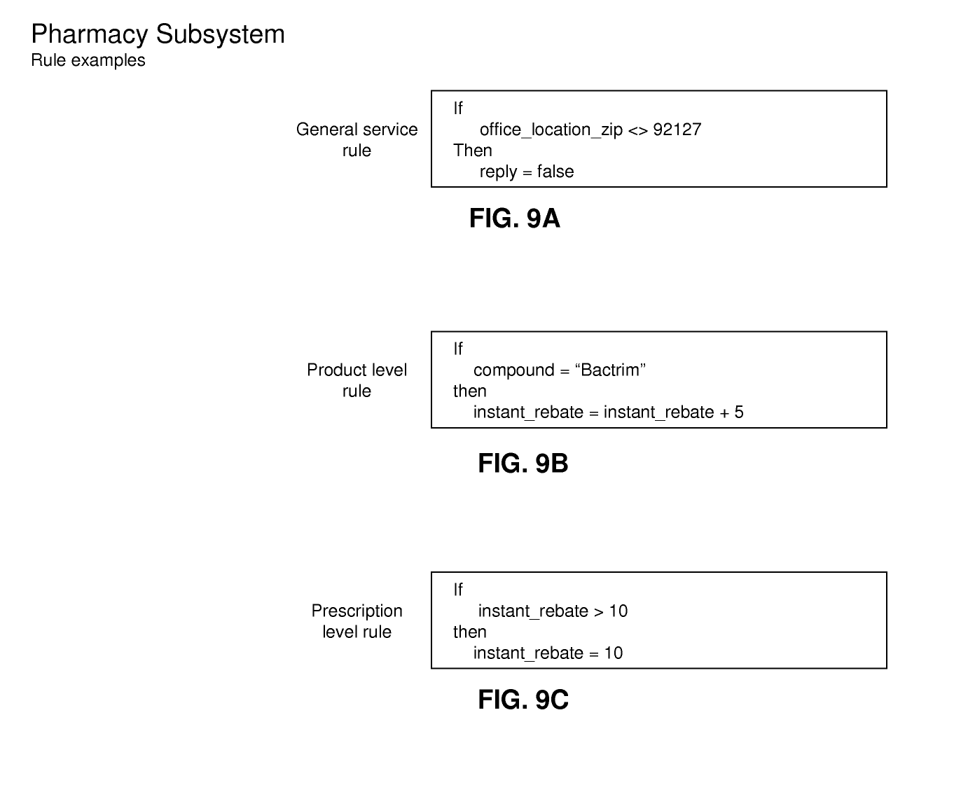

FIG. 9 is a process flow diagram depiction of an exemplary embodiment of element 236 discussed with respect to FIG. 7. According to 270 pharmacy 10 accesses and utilizes rule management module 104 to transfer rule information to pharmacy subsystem 54.

According to 272, pharmacy system 10 accesses and utilizes rule management module 104 to transfer general service rules information to pharmacy subsystem 54. An example of a general service rule is depicted in FIG. 9A.

According to 274, pharmacy system 10 accesses and utilizes rule level management module 104 to transfer product level rule information to pharmacy system 54. An example of a product level rule is depicted in FIG. 9B. Product level rule information defines sales incentives based upon the type of product or service or compound being dispensed.

According to 276, pharmacy system 10 accesses and utilizes rule level management module 104 to transfer prescription level rule information to pharmacy system 54. An example of a prescription level rule is depicted in FIG. 9C. Prescription level rule information defines rules based on details of the actual prescription.

According to 278, a rule test procedure takes place. Pharmacies can execute a battery of predefined tests that include both system performance and response content. System performance allows a pharmacy to test the technical performance of the quotation server. Response content tests allow pharmacies to respond to simulated prescriptions and compare their offer responses with the expected responses. Pharmacies can adjust their rule sets if and when actual responses vary from expected ones.

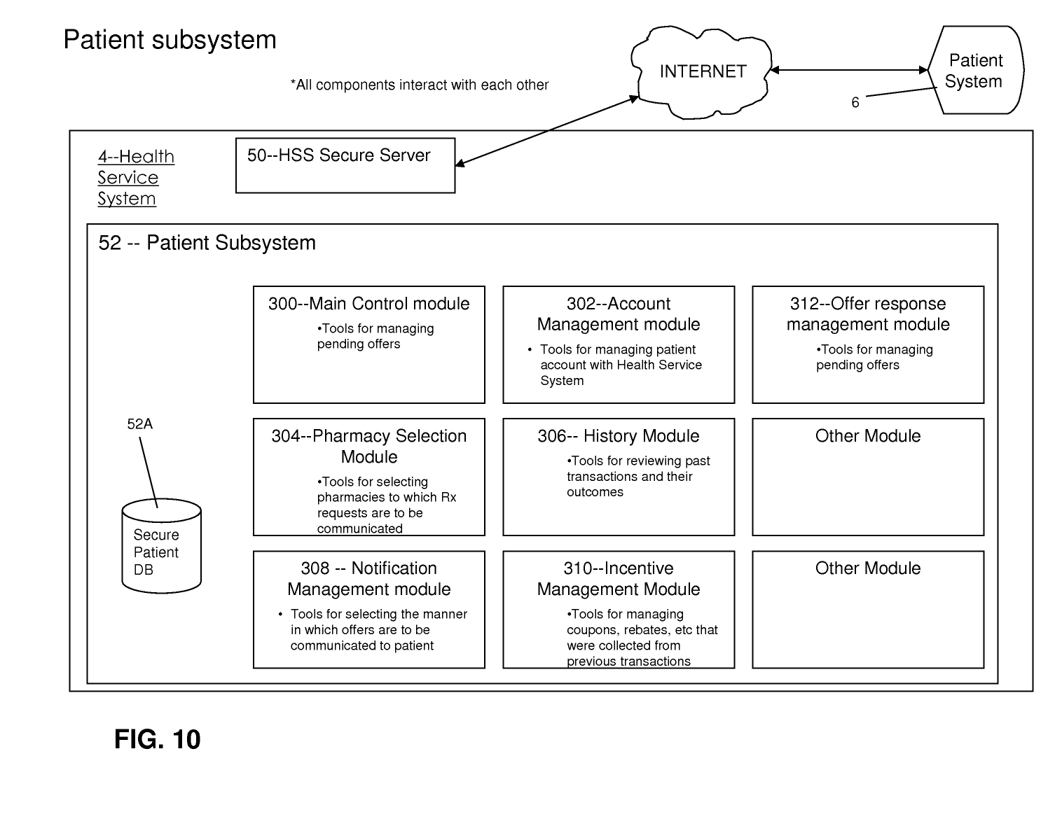

An exemplary embodiment of patient subsystem 52 is depicted in block diagram form in FIG. 10. Patient system 6 directly controls patient subsystem 52. In the discussion that follows we will refer to the control by one patient system 6 but it will be understood that provision is made for numerous patient systems to independently access subsystem 52 in health service system 4.

Patient subsystem 52 includes a main control module 300, an account management module 302, a pharmacy selection module 304, a history module 306, a notification management module 308, an incentive management module 310, and an offer response management module 312.

Main control module 300 includes tools for managing the main or primary functions of patient subsystem 52. Account management module 302 includes tools for managing the patient account with the health service system 4.

Pharmacy selection module 304 includes tools for selecting pharmacies to which RFQS (requests for quote) are to be communicated for each patient. Pharmacy selection module 304 receives pharmacy preference information from the patient system 6 that defines the pharmacies from which to obtain offers or offer information.

History module 306 includes tools for reviewing past transactions and their outcomes. Notification management module 308 includes tools for selecting the manner in which offers are to be communicated to each patient. Incentive management module 310 includes tools for managing coupons, rebates, etc., that were collected from previous transactions. Offer response management module 312 includes tools for managing pending offers.

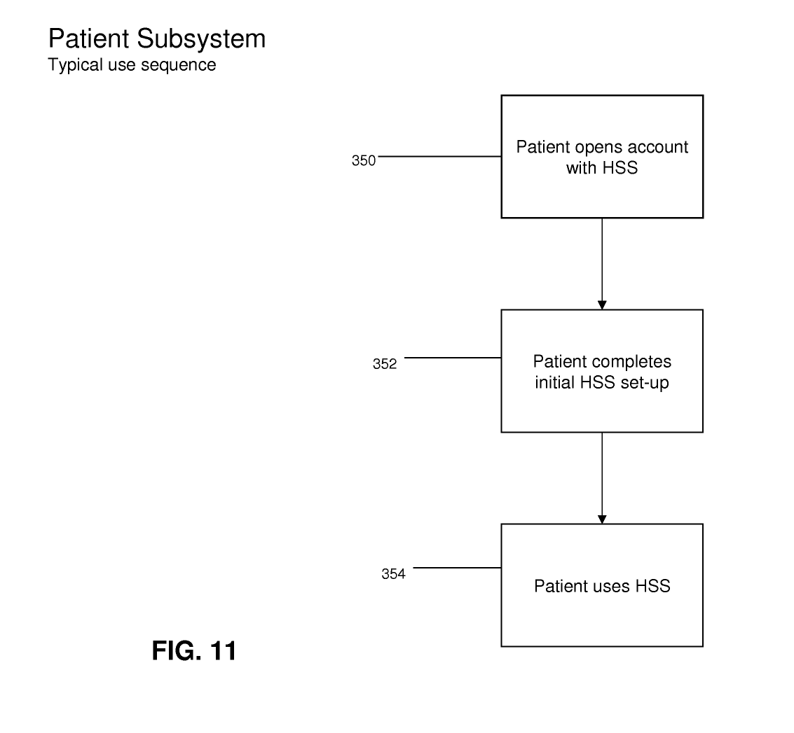

FIG. 11 is a flow chart depiction of an interaction between patient subsystem 52 and patient system 6. According to 350, a patient opens an account with health service system 4. In a preferred embodiment, patient system 6 accesses and utilizes account management module 302 to transfer initial account information to patient subsystem 52.

According to 352, the patient completes an initial setup with the health service system 4. In a preferred embodiment, patient system 6 accesses and utilizes account management module 302, pharmacy selection module 304, notification management module 308, and offer preference management module 312 to transfer additional information to patient subsystem 52 as will be elaborated later.

According to 354, the patient can then use the health service system to process prescriptions.

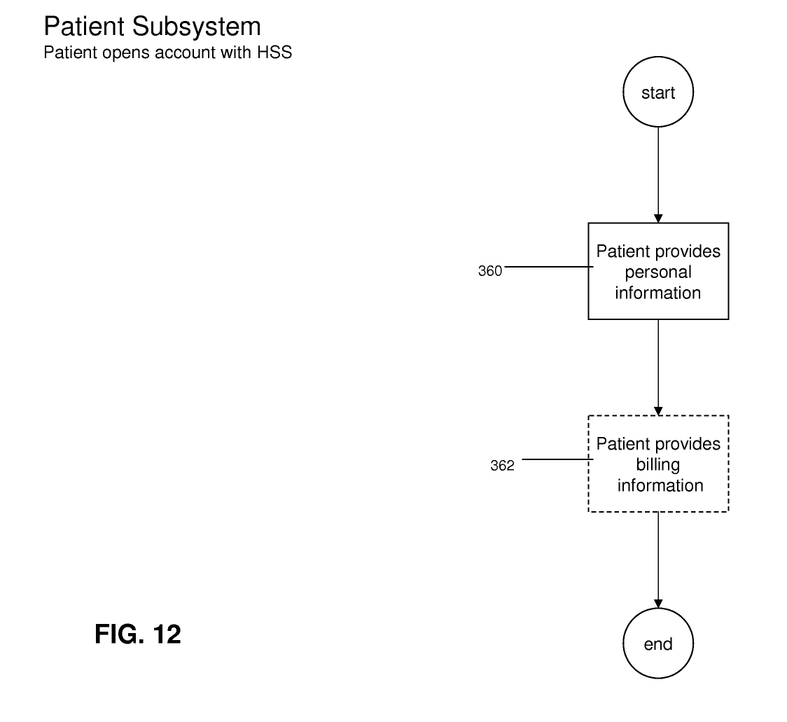

FIG. 12 is a flow chart that depicts a process by which a patient opens an account with health service system 4. According to 360, the patient provides personal information to health service system 4. In one embodiment, patient subsystem 52 receives the personal information from patient system 6 through the use of account management module 302. In a second embodiment embodiment, the patient provides personal information to health service system 4 from a doctor's office. In the second embodiment, the personal information of the patient is received from a healthcare provider system 8.

According to 362, the patient provides billing information to health service system 4. In one embodiment, patient subsystem 52 receives the billing information from patient system 6. In a second embodiment, the patient provides billing information to health service system 4 from a doctor's office. In the second embodiment, the billing information of the patient is received by patient subsystem 52 from a healthcare provider system 8.

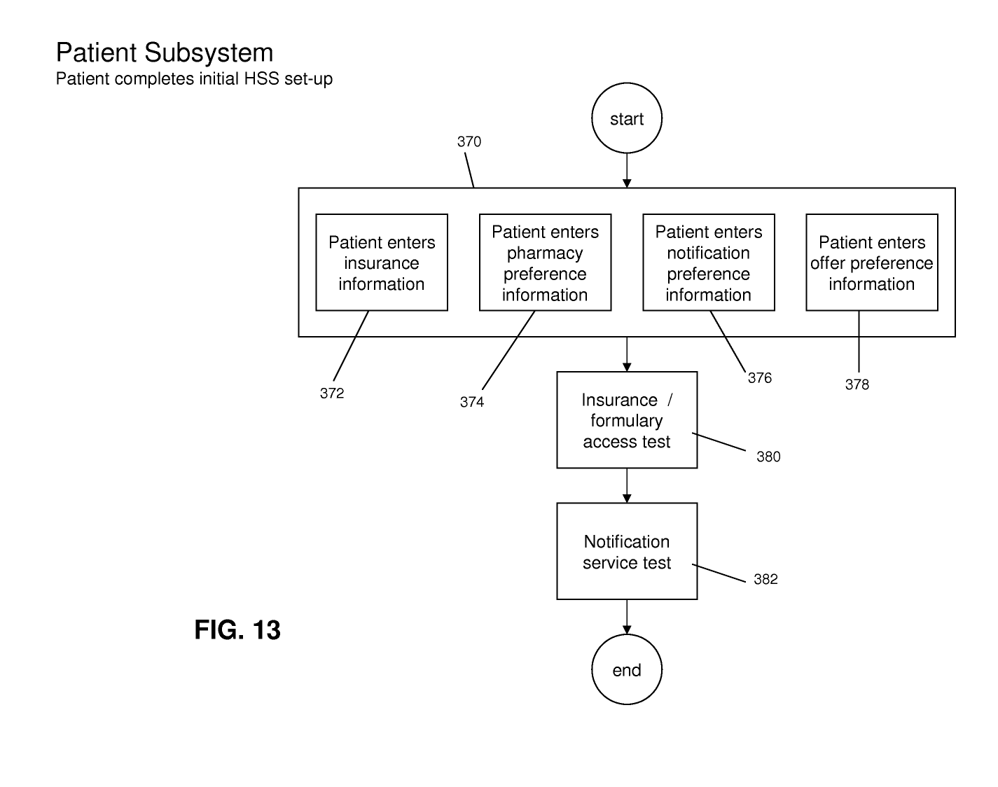

FIG. 13 is an exemplary embodiment of element 352 discussed with respect to FIG. 11. FIG. 13 is a process flow diagram representation of completing the initial set up of the account between the patient and the health service system 4.

According to 372 the patient provides insurance information to health service system 4. In a preferred embodiment, patient system 6 accesses and utilizes tools from account management module 302 to transfer insurance information to patient subsystem 52.

According to 374 the patient provides pharmacy preference information to health service system 4. In a preferred embodiment, patient system 6 accesses and utilizes tools from pharmacy selection module 304 to transfer pharmacy selection information to patient subsystem 52.

According to 376 the patient provides notification preference information to health service system 4. In a preferred embodiment, patient system 6 accesses and utilizes tools from notification management module 308 to transfer notification management information to patient subsystem 52.

According to 378 the patient provides offer preference information to health service system 4. In a preferred embodiment, patient system 6 accesses and utilizes tools from offer response management module 312 to transfer offer response preference information to patient subsystem 52.

According to 380, health service system 4 performs a test to verify access to insurance and formulary information to verify patient coverage and formulary availability.

According to 382, health service system 4 performs a notification service test to verify the notification system utilized between patient subsystem 52 and patient system 6.

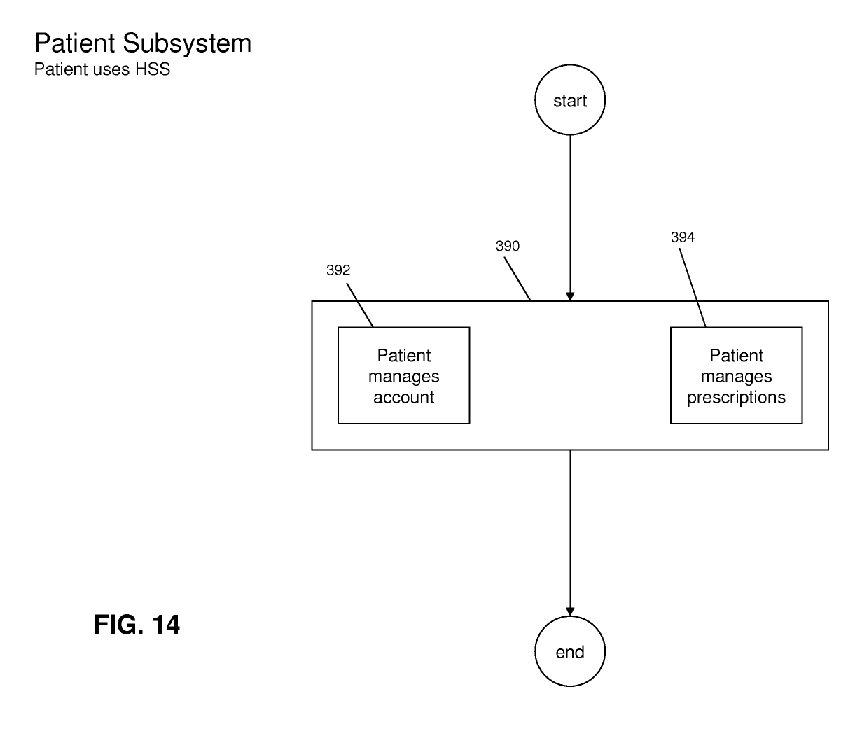

FIG. 14 depicts the process wherein the patient uses the health service system 4 according to element 354 of FIG. 11. According to element 390, the patient manages information and processes utilized by patient subsystem 52. In a preferred embodiment, patient subsystem 52 receives information from patient system 6 defining refinements to the operation of patient subsystem 52.

According to 392, the patient manages his or her account with health service system 4. In an exemplary embodiment, patient subsystem 52 receives account management information from patient system 6. Patient system 6 provides account management information by accessing and utilizing the tools provided in account management module 302.

According to 394, the patient manages his or her prescriptions. In a preferred embodiment, patient subsystem 52 receives prescription management information from patient system 6. Patient system 6 provides prescription management information by accessing and utilizing the tools provided in pharmacy selection module 304 and/or offer response management module 312.

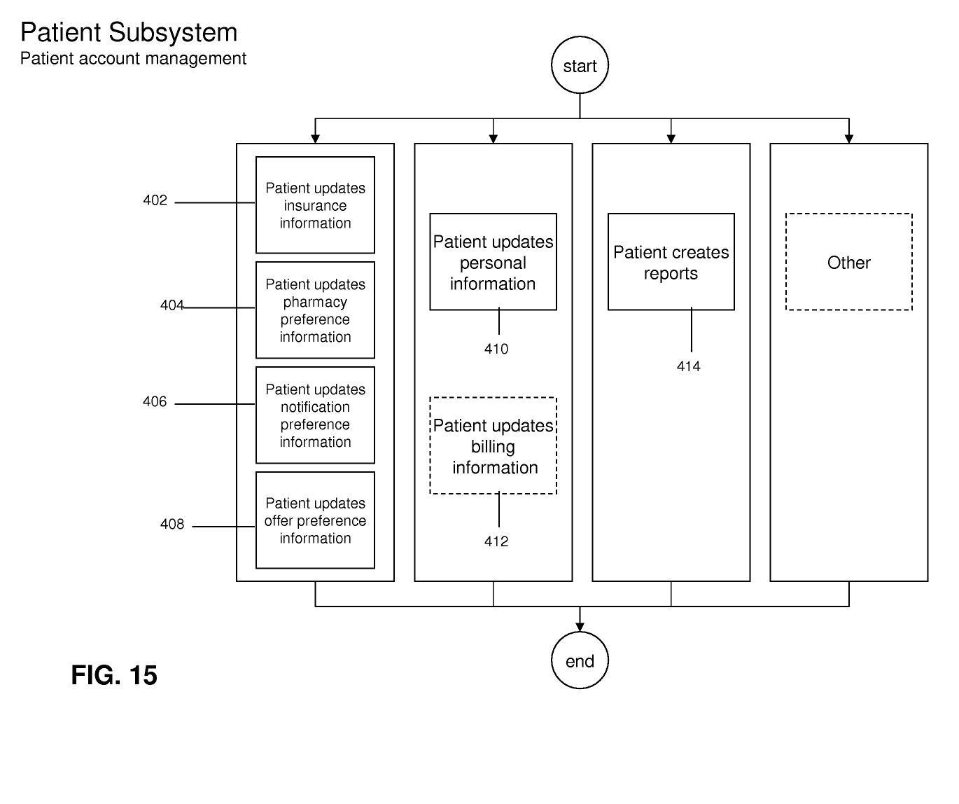

A more detailed exemplary embodiment of an account management process of element 392 of FIG. 14 is depicted in FIG. 15 in process flow form. According to 402, patient subsystem 52 receives updated insurance information from patient system 6.

According to 404, patient subsystem 52 receives updated pharmacy preference information from patient system 6. Patient system 6 provides updated pharmacy preference information to patient subsystem 52 by accessing and utilizing the tools in pharmacy selection module 304.

According to 406, patient subsystem 52 receives updated notification preference information from patient system 6. According 408, patient system 6 provides notification preference information to pharmacy subsystem 52 by accessing and utilizing the tools in notification management module 308.

According to 410, patient subsystem 52 receives updated personal information from patient system 6 when patient system 6 accesses and utilizes the tools provided in account management module 302. According to 412, patient subsystem 52 receives updated billing information from patient system 6. According to 414, the patient creates reports from patient subsystem 52 by accessing and utilizing the tools provided in history module 306.

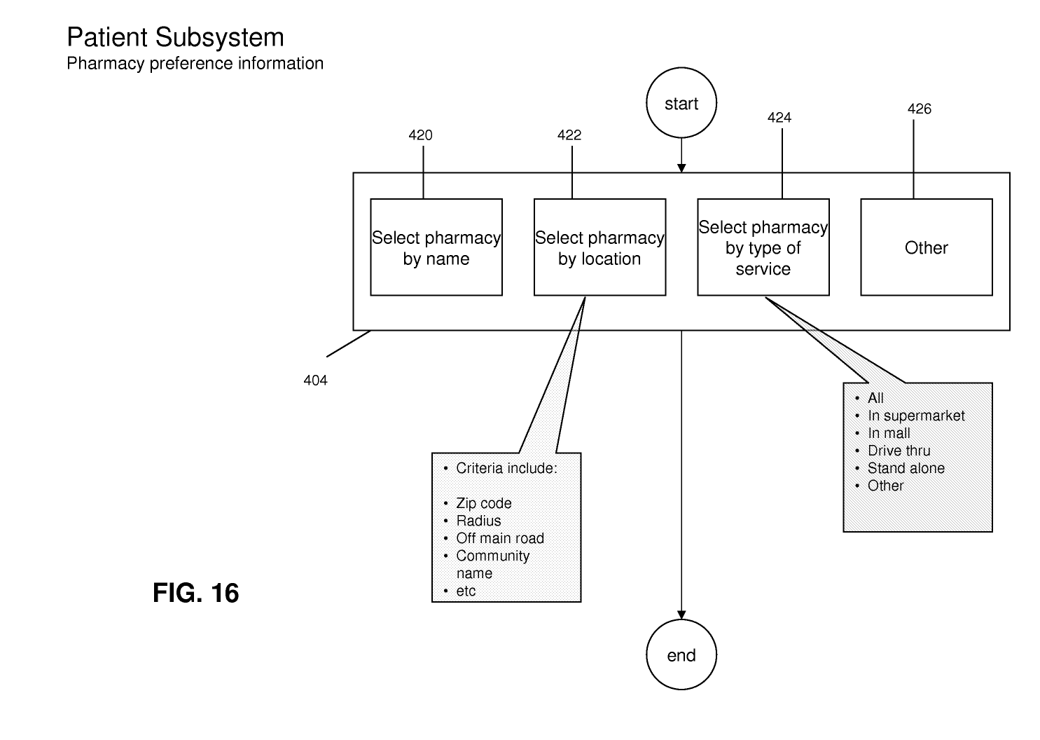

A more detailed exemplary embodiment of defining pharmacies from which to receive offers, referred to as element 374 of FIG. 13 or as element 404 in FIG. 15, is depicted in the process flow diagram of FIG. 16. Elements 420, 422, 424, and 426 are indicative of alternative or parallel criteria for selecting the pharmacies from which to receive offers and are accomplished when the patient system accesses and utilizes tools provided by the pharmacy selection module 304. According to 420, patient subsystem 52 receives pharmacy selection information from patient system 6 that is indicative of the name(s) of pharmacies selected. According to 422, patient subsystem 52 receives pharmacy selection information from patient system 6 that is indicative of the locations of pharmacies selected. According to 424, patient subsystem 52 receives pharmacy selection information from patient system 6 that is indicative of the types(s) of pharmacies selected. According to 420, patient subsystem receives pharmacy selection information from patient system 6 based on other criteria or based upon a combination of the criteria utilized by elements 420-424.

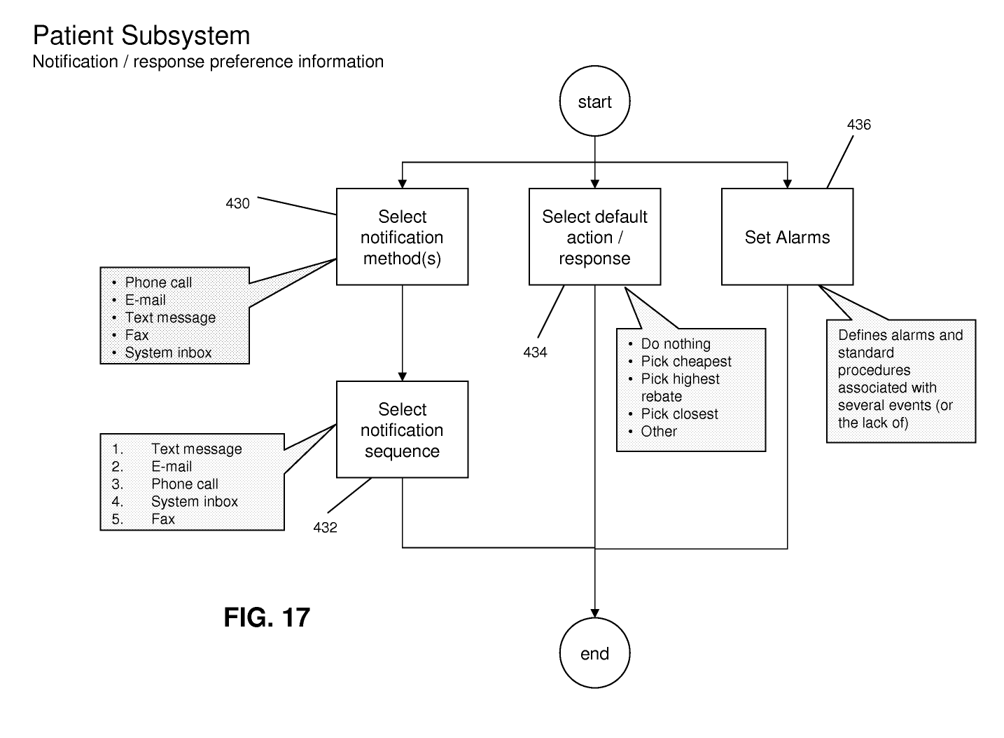

A more detailed exemplary embodiment of defining notification and response preference information, referred to as element 376 of FIG. 13 or as element 406 in FIG. 15, is depicted in process flow diagram form in FIG. 17.

According to 430, patient subsystem 52 receives selection notification method information from patient system 6 through the tools provided in notification management module 308. The selection notification method information defines what forms of notifications that the patient subsystem can use to inform contact the patient. Exemplary forms of notification include phone calls, electronic mail messages, text messages, faxed messages, and system inbox messages to name a few.

According to 432, patient subsystem 52 receives notification sequence information from patient system 6 through the tools provided in notification management module 308. The notification sequence information defines the order in which different forms of notification will take place. For example, the patient subsystem 52 may start with a text message and/or electronic mail to begin with. If not patient response is received within a certain specified time, then an automated phone call may be placed.

According to 434, patient subsystem 52 receives default action/response selection information from patient system 6 through the tools provided in offer response management module 312. The default action/response selection information defines criteria by which offers are to be selected.

According to 436, patient subsystem 52 receives alarm information from patient system 6 through the main control module 300. The alarm information defines by what criteria to inform the patient when certain events occur or do not occur properly.

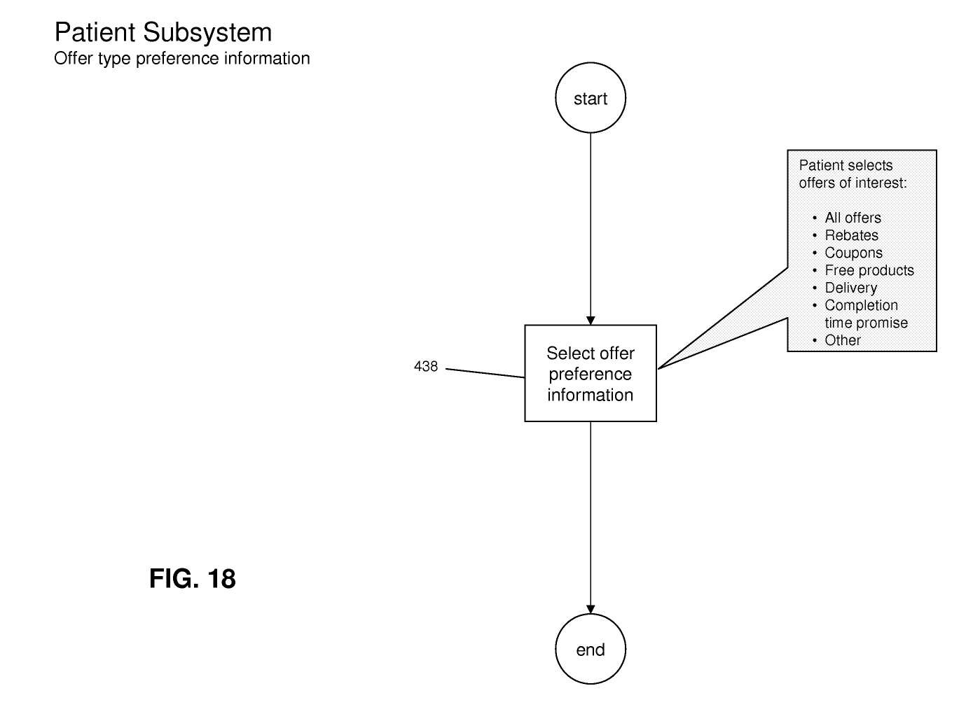

An exemplary embodiment of how a patient selects what offers are of interest or of most interest, referred to as element 378 of FIG. 13 or as element 404 in FIG. 15, is depicted in FIG. 18. According to 438, patient subsystem 52 receives offer preference information from patient system 6 through the use of offer preference management module 312. Offer preference information defines and/or prioritizes the types of offers the patient is most interested in. For example, a patient may be more interested in getting free products than in getting rebates.

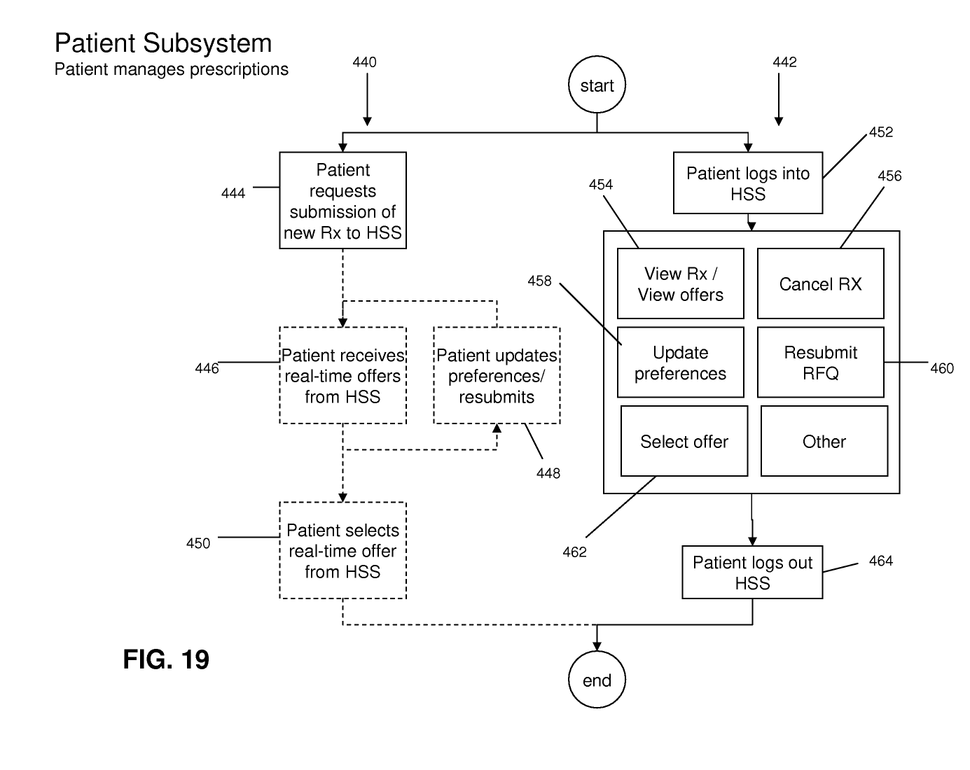

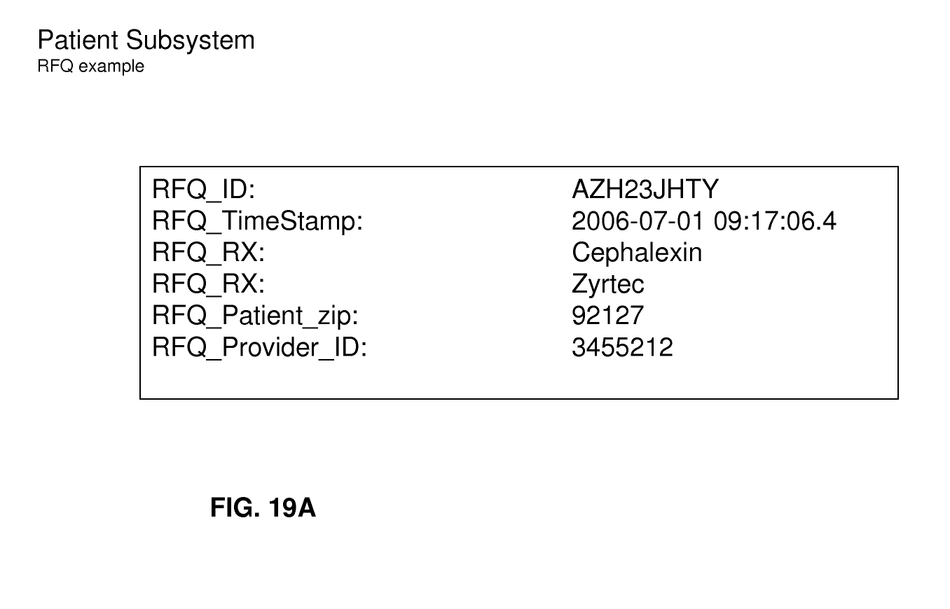

An exemplary embodiment of how a patient manages prescriptions, referred to as element 394 in FIG. 14, is depicted in process flow diagram form in FIG. 19. The left-hand side of FIG. 19, referred to as 440, depicts a “real time” sequence that may occur between an Rx being generated for a patient and the patient selection of an offer from a pharmacy 10. The right hand side of FIG. 19, referred to as 442, depicts “asynchronous” functions performed by the patient who logs in to the patient subsystem 52 and depicts an alternative sequence between the Rx being generated and the patient selecting an offer.

Starting with left-hand side 440, a patient requests submission of a new Rx to the health service system 4 according to 444. Most likely this is accomplished while the patient is visiting a practitioner. After 444, the Rx is transferred to the health service system 4. According to 446, the patient receives offers from health service system 4. These offers may be based on the Rx, rules, and patient set up procedures discussed earlier. The offers may be received via email, phone, etc., as discussed with respect to FIG. 17. According to 448, the patient may, if preferred, update preferences (included in element 392 of FIG. 13) and then resubmit the Rx. On the other hand, the patient may select one of the real time offers according to 450.

Functions performed on the right-hand side 442 may occur after the patient requests submission of the Rx to the health service system 4. According to 452, the patient logs into the health service system 4. Once logged in, the patient has the option performing any or all of the functions 454, 456, 458, 460, and/or 462. According to 454 the patient subsystem 52 is configured to allow the patient to view pending prescriptions or offers. According to 458 and 460, the patient subsystem 52 is configured to allow the patient to update preferences and to resubmit an RFQ. An example of RFQ information is depicted with respect to FIG. 19A. According to 462, the patient elects to select an offer (that the health service system 4 then presents as an order that is routed to the pharmacy system 10. According to 464, the patient logs out from the health service system 4.

A more detailed exemplary embodiment of how the patient receives real-time offers from the health service system 4, referred to as element 446 in FIG. 19, is depicted in FIG. 20 in process flow diagram form. According to 446, the patient may receive real time offers in the form of an electronic mail 470, a text message 472, a voice message 474, a real person 476 (for example, calling the patient), a fax 478, or other communication methods. As discussed with respect to FIG. 16, the modes of communication and/or the sequence of the modes can be pre-selected by the patient.

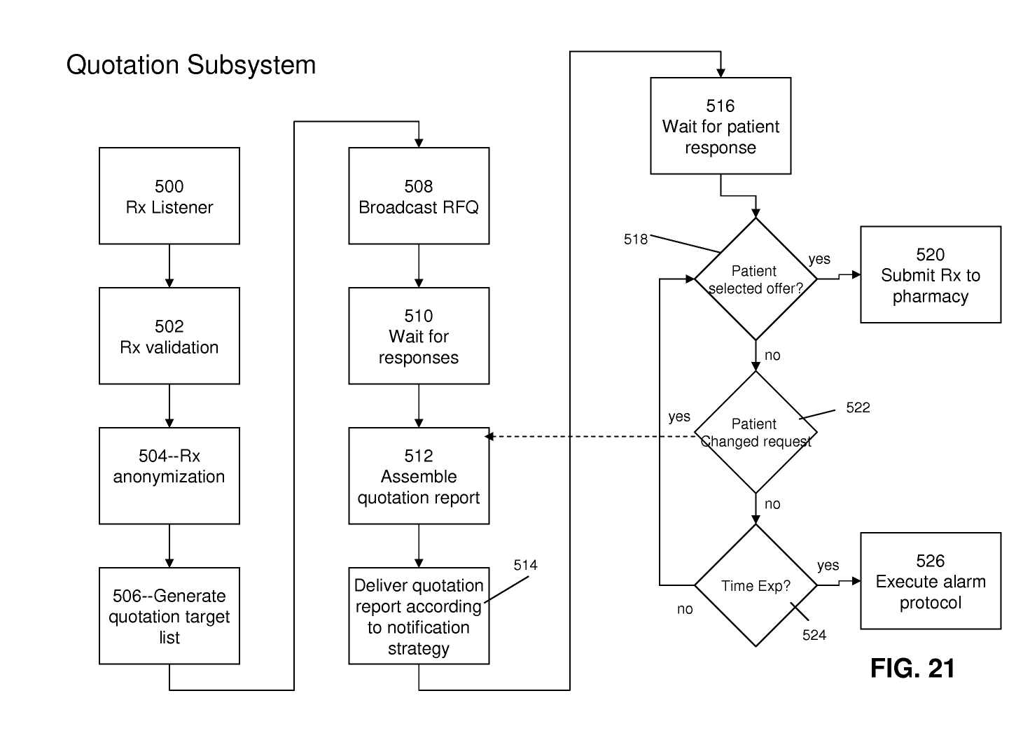

A flow chart representation of the operation of quotation subsystem 56 is depicted in FIG. 21. According to 500, quotation subsystem 56 is in a “listen mode” and receives an indication of an Rx for a patient arriving from a healthcare provider system 8. According to 502, the quotation subsystem 56 validates the Rx.

According to 504, quotation subsystem 56 removes information from the Rx that would identify the patient. This results in an abridged Rx and/or an RFQ (request for quote) without patient identity information.

According to 506, quotation subsystem 56 generates a target list of pharmacies 10 from which to obtain offers. The target list is based on inputs provided by the patient through the use of tools provided by the pharmacy selection module 304 (see FIG. 10) and may be specified by a method depicted according to FIG. 16.

According to 508, quotation subsystem 56 broadcasts the RFQ to the pharmacy systems 10. In one embodiment, the RFQ is transferred to a prescription quotation or response server 110 for each pharmacy 10.

According to 510 quotation subsystem 56 waits for responses from pharmacies 10. According to 510, responses are received at the quotation subsystem 56 from the prescription quotation server(s) 110.

According to 512, the quotation subsystem 56 assembles a quotation report based upon the responses from the prescription quotation server(s) 110. This quotation report comprises offer information as discussed at the beginning of this specification.

According to 514, quotation subsystem 56 delivers the quotation report to the patient according to a notification strategy. The notification strategy is the manner in which the offers can be communicated to the patient, as discussed with respect to FIGS. 17 and 20.

According to 516, quotation subsystem 56 waits for a patient response from patient system 6. According to decision 518, if the patient selects an offer (within a certain time period) then the Rx will then be submitted to a selected pharmacy according to 520. Stated another way, if quotation subsystem 56 receives offer selection information from patient system 6, then quotation subsystem will transmit a fully qualified Rx order to a selected pharmacy 10 as defined by the offer selection information.

According to 522, if the quotation subsystem 56 receives a change in the request, then the quotation report will be reassembled according to 512 and the process will start again at 512. If there is no response from the patient at all and a certain predetermined time elapses according to 524, then an alarm protocol will be executed according to 526.

What is claimed is:

1. A method for optimizing the filling of prescriptions comprising:
providing a health service system;
receiving prescription information at the health service system;
processing the prescription information to define offer information that is indicative of a plurality of individual offers for each of a plurality of pharmacies respectively; and
transferring the offer information to a patient system.

2. The method of claim 1 further comprising receiving pharmacy preference information from the patient system, the pharmacy preference information is indicative of the plurality of pharmacies.

3. The method of claim 1 wherein the prescription information is received from a healthcare provider system.

4. The method of claim 1 wherein processing the prescription information includes:
transferring the prescription information to a plurality of pharmacy systems; and
receiving the individual offer information from each of the plurality of pharmacies.

5. The method of claim 1 wherein processing the prescription information includes:
removing information defining a patient identity from the prescription information to define abridged prescription information;
transferring the prescription information to a plurality of pharmacy systems; and
receiving the individual offer information from each of the plurality of pharmacies.

6. The method of claim 1, further comprising:
receiving offer selection information from the patient system that is indicative of the selection of one of the plurality of individual offers;
processing the offer selection information to define order information; and
transferring the order information to one of the plurality of pharmacies that corresponds to the selection of one of the plurality of individual offers.

7. A health service information technology system comprising:
a pharmacy subsystem configured to be managed by a pharmacy and containing pharmacy information provided by a pharmacy system; and
a patient subsystem configured to be managed by a patient and containing patient information provided by the patient.

8. The health service information technology system of claim 7, further comprising a quotation subsystem configured to receive prescription information and to process the prescription information based upon the pharmacy information and the patient information.

9. The health service information technology system of claim 7 wherein the pharmacy subsystem includes a module enabling the pharmacy system to transfer information that configures the operation of the pharmacy subsystem.

10. A method of generating a prescription order for a patient comprising:
receiving first information defining a prescription;
processing the first information to define second information defining a plurality of quotations;
delivering the second information the patient; and
receiving third information from the patient defining selection of a single quotation from the plurality of quotations.

11. The method of claim 10 wherein the first information is received from a patient system.

12. The method of claim 10 wherein processing the first information includes removing information that is indicative of the identity of the patient.

13. The method of claim 10 wherein processing the first information includes:
generating a request for quote;
generating a target list of pharmacies from which to obtain quotations;
distributing the request for quote to the target list;
receiving quotation information from pharmacy systems from within the target list of pharmacies;
processing the quotation information to form the second information.

14. The method of claim 10, wherein a mode of delivering the second information to the patient is selected from a list consisting of a phone call, an electronic mail, a text message, a fax, and a system inbox.

15. The method of claim 10 wherein more than one mode of delivering is used in a pre-selected sequence.

16. The method of claim 10, wherein the delivering the second information to the patient includes transferring the second information to the patient system, the patient system selected from a list consisting of an information technology system, a personal computer, a laptop computer, a cellular phone, and a personal data assistant.

17. The method of claim 10 wherein delivering the second information to the patient includes receiving a log in from a patient system and displaying the second information on the patient system.

18. The method of claim 10 further comprising receiving pharmacy selection information from a patient system defining a target list of pharmacies from which to obtain the plurality of quotations.

19. The method of claim 10 further comprising:
generating an order based upon the third information; and
transferring the order to a pharmacy system.
